(19) United States
(12) Patent Application Publication
(10) Pub. No.: US 2016/0214541 A1
(43) Pub. Date: Jul. 28, 2016

(54) RV/MOTORHOME AWNING UTILITY BRACKET/RACK

(71) Applicant: William Charles LOVEJOY, Brighton, TN (US)

(72) Inventor: William Charles LOVEJOY, Brighton, TN (US)

(21) Appl. No.: 14/608,131

(22) Filed: Jan. 28, 2015

(51) Int. Cl. B60R 9/00

(52) U.S. Cl. CPC B60R 9/00

(57) ABSTRACT

A C-shaped utility bracket with tensioner designed to attach to the awning leg of an RV or motorhome. The inner surface of the device is padded to provide both secure fit and prevent marring. On one end of the threaded tensioning rod is a unique rack consisting of 6 slotted locations for storage and stacking. On the opposite end of the tensioner is an eye bolt used as an alternative attaching point for ropes, lines, etc. The tensioning rod components, consisting of the eyebolt and slotted rack, are connected via a coupling union. Appropriately sized nuts are provided and threaded to the tensioning rod at the outsides of the clamp so as to provide stabilizing compression upon the awning leg.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

As a recreational vehicle/motorhome (RV) owner and traveler, I have experienced numerous occasions when I lacked either an attachment point or storage location for apparatus. These items were lain against the RV and subject to falling from wind or casual contact. In addition, the awning lacked an attachment point for secure tie-down. I found this frustrating and found nothing as a suitable device or tool in any RV stores or catalogs. Internet searches revealed that nothing existed. I needed a place to stack fishing rods, boat paddles, hang life jackets or plants, and to provide an additional attachment point for secure awning tie down lines. I designed and manufactured the RV/Motorhome Awning Utility Bracket/Rack to resolve the issues.

### BRIEF SUMMARY OF THE INVENTION

The invention is attached to the RV/motorhome awning supporting leg when the awning leg base is either attached to the RV or extended. With the c-clamp positioned around the awning leg and secured with the eye bolt, nut, and rack, the invention can be used to hang loads up to 20 pounds, stack sporting equipment, secure the awning canopy, etc. The invention is a practical solution to prevent valuable equipment from damage while on the ground, or marring the exterior finish of the RV. The 6 rubber coated stacking slots protect equipment stored there. The cushioned interior of the invention aids in preventing marring of the awning leg as well as increasing the holding ability of the bracket to the awning leg. Uses to which the bracket and rack can be applied include convenient placement of mops, brooms; staging of fishing rods, paddles, rifles, boat paddles. Eye bolts can be used to hold flag poles, plants etc. as well as serve as attaching points for awning security tie down lines. The invention is removed when the awning is placed in the stowed position for travel.

### DETAIL DESCRIPTION OF SEVERAL VIEWS OF THE DRAWING

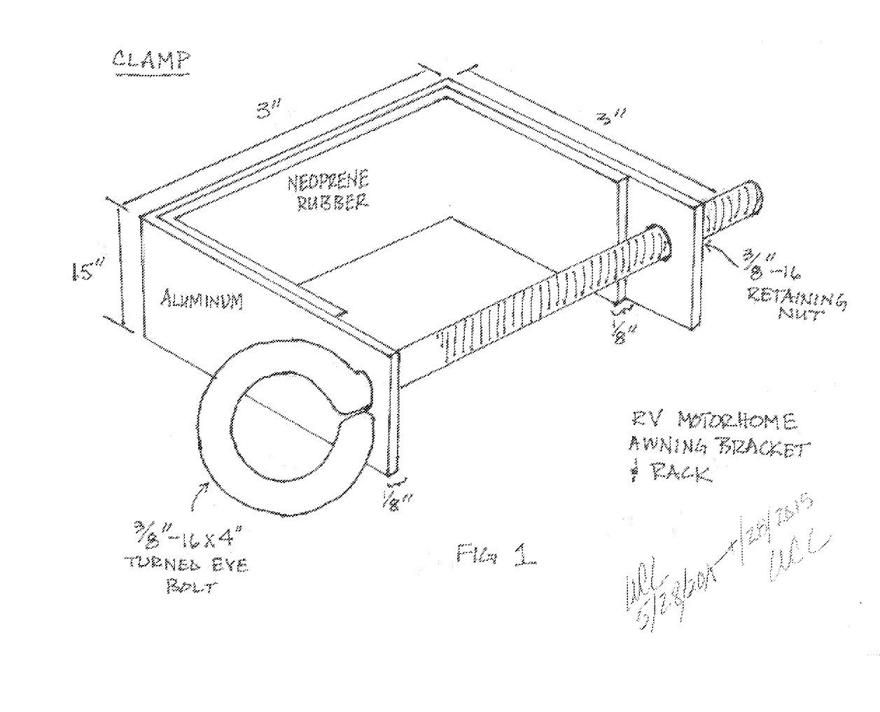

The item is described (FIG. 1)) as a C-clamp style bracket having straight legs; each of approximately 3 inches in length. The bracket material is aluminum, approximately 0.125 inches in thickness, 1.5 inches in width and in its unbent length, 9.5 inches long. Each leg measures approximately 3 inches in length and the bracket back is 3.5 inches in length. A 0.4375 inch opening is drilled approximately 0.75 inches from the leg end. The inner portion of the bracket is covered with 0.25 inches of cushioning rubber from a point just below the opening, down the leg-across the back and up the opposite leg to just below the opening.

A 7 inch by ⅜ inch rod with 1 inch of size 16 thread is inserted through the bracket leg holes and serves as the closure compression device to hold the bracket securely to the awning leg. Two ⅜-16 nuts are provided to fasten to the outer portion of the threaded rod to apply tension to the bracket and keep it in place against the awing leg. This serves as the connecting and tensioning rod to the rack. The bracket is locatable anywhere along the length of the awning leg. In addition, multiple brackets may be applied to a single awning; each for its specific purpose.

The bitter ends of the threaded rod are available to attach to a ⅜-15 union coupling, and to which any ⅜-16 appliance may be attached, e.g. eye bolts of assorted length, hooks, additional rods, etc.

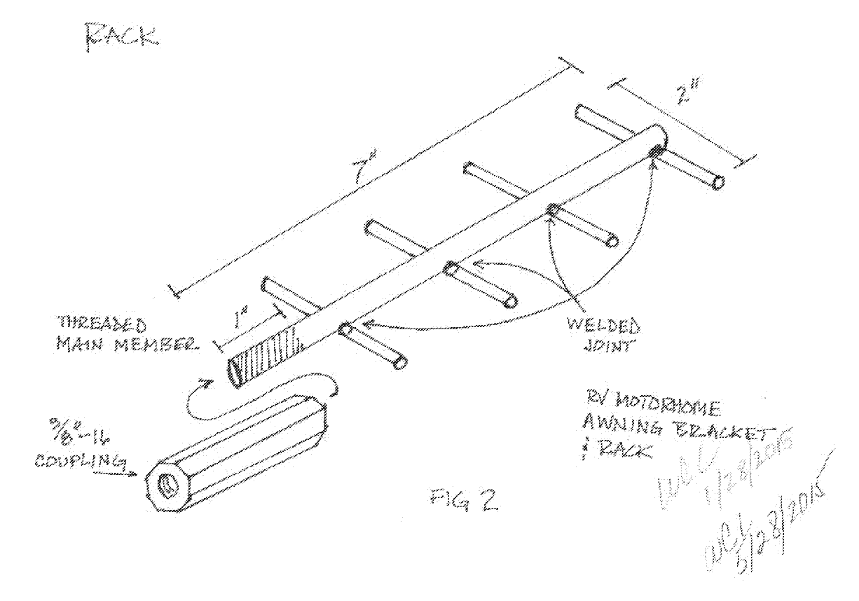

The “rack” device (FIG. 2) is described a a ⅜ inch metal rod to which 4 each 0.125 by 2 inch rods are permanently welded as cross members. This configuration provides for six slotted spaces, three of each side of the main metal member. The bitter end of the main member is threaded 1 inch to ⅜-16 specifications in order that the main member can attach to the bracket via the ⅜-16 union coupling. This “rack” is coated with a rubberized coating for protection from the elements and to reduce marring of the RV awning leg.

1. I, William C. Lovejoy, claim that the invention described herein is original in its design and application and is considered my property. Any reproduction or similar representation of my invention is considered infringement.
